(19) United States
(12) Patent Application Publication
(10) Pub. No.: US 2013/0043182 A1
(43) Pub. Date: Feb. 21, 2013

(54) WATER FILTER

(71) Applicant: Pin-Yi Chung, Taipei County (TW)

(72) Inventor: Pin-Yi Chung, Taipei County (TW)

(21) Appl. No.: 13/609,273

(22) Filed: Sep. 11, 2012

Related U.S. Application Data
(63) Continuation-in-part of application No. 12/951,086, filed on Nov. 22, 2010, now abandoned.

(51) Int. Cl. B01D 29/15; B01D 29/50

(52) U.S. Cl. 210/454; 210/485

(57) ABSTRACT

A filter for filtering water includes a compound material installed between the upper supporting seat and the lower supporting seat; the compound material being formed with an high density fiber layer, an active carbon layer surrounding the high density fiber layer and a fiber layer surrounding the active carbon layer; the upper supporting seat having a cover plate, an inner ring, an middle ring and an outer ring; the lower supporting seat having a cover plate; an inner ring; a middle ring and an outer ring; the high density fiber layer being installed between the platforms of the upper and lower supporting seat; the active carbon layer being installed between the fiber filtering material of the upper supporting seat and the fiber filtering material of the lower supporting seat; and the fiber layer being installed between the upper and lower supporting seat.

The present invention is a continuation in part (CIP) of U.S. patent application Ser. No. 12/951,086 which is assigned to the applicant of the present invention, and thus the contents of Ser. No. 12/951,086 is incorporated into the present invention as a part of the present invention.

### FIELD OF THE INVENTION

The present invention relates to filters, in particular to a water filter with filtering materials of fibers, active carbons, and high density fibers as a computer filter material so as to get pure water.

### BACKGROUND OF THE INVENTION

A prior art filter is illustrated in FIGS. 1 and, in that a hollow cylinder 11 has threaded sections 12, 13 for screwing with a top cover 14 and a seat 15 so as to form as a filter cylinder 10. A hollow body 11 of the cylinder 10 is installed with filter stones 31, electric stones 32 and negative ion stones 33 which are formed as filter material 30. A filtering net 18 is installed at a water inlet 17 of the seat 15. Water flows into the inlet 17 and then flows through the filter material 30 to be outputted from the water outlet tube 16 so that the output water become odorless and pure. However, in this prior art the water inlet 17 is limited by the size of the cylinder 10 so that only a little water can be filtered. Moreover, the water inlet 17 is easy to be blocked so that the filtering function can not be functioned. Moreover, the filter material 30 is a plurality of stones which are heavy and thus are difficult to be transferred. Furthermore, this prior art is difficult to update the filter material. Commonly, it is needed to update the whole filter material, while this is expensive.

### SUMMARY OF THE INVENTION

Accordingly, the primary object of the present invention is to provide a water filter with filtering materials of filters, active carbons, and high density filters as a computer filter material so as to get pure water.

To achieve above objects, the present invention provides a filter for filtering water, comprising: a compound material installed between the upper supporting seat and the lower supporting seat; the compound material being formed with an high density fiber layer, an active carbon layer surrounding the high density fiber layer and a fiber layer surrounding the active carbon layer; the upper supporting seat having a cover plate; an inner ring protruding from a lower side of the cover plate of the upper supporting seat; the reduced ring protruding from a lower side of the inner ring so as to form with a platform at the lower side of the inner ring and surrounding the reduced ring; a middle ring protruding from the cover plate and surrounds the inner ring; an outer ring protruding from the lower side of the cover plate and surrounds the middle ring; a central portion of the upper supporting seat being formed with a water outlet; a fiber filtering material being placed into a space between the inner ring and the middle ring; the lower supporting seat having a cover plate; an inner ring protruding from a upper side of the cover plate of the lower supporting seat; the reduced ring protruding from an upper side of the inner ring so as to form with a platform at the upper side of the inner ring and surrounding the reduced ring; a middle ring protruding from the cover plate and surrounds the inner ring; an outer ring protruding from the upper side of the cover plate of the lower supporting seat and surrounding the middle ring; a central portion of a lower side of the lower supporting seat being formed with a lower recess; a fiber filtering material being placed into a space between the inner ring and the middle ring; the high density fiber layer being installed between the platform of the upper supporting seat and the platform of the lower supporting seat; the active carbon layer being installed between the fiber filtering material of the upper supporting seat and the fiber filtering material of the lower supporting seat; the fiber layer being installed between the upper supporting seat and the lower supporting seat; one end of the fiber layer being engaged to a recess between the middle ring of the upper supporting seat and the outer ring of the upper supporting seat; another end of the fiber layer being engaged to a recess between the middle ring of the lower supporting seat and the outer ring of the lower supporting seat.

The various objects and advantages of the present invention will be more readily understood from the following detailed description when read in conjunction with the appended drawing.

### BRIEF DESCRIPTION OF THE DRAWINGS

FIG. 1 shows the prior art filter.

FIG. 2 shows another prior art filter.

FIG. 3 is an exploded perspective view of the present invention

FIG. 4 is an assembled cross section view of the present invention.

FIG. 5 is a schematic cross section view of the present invention.

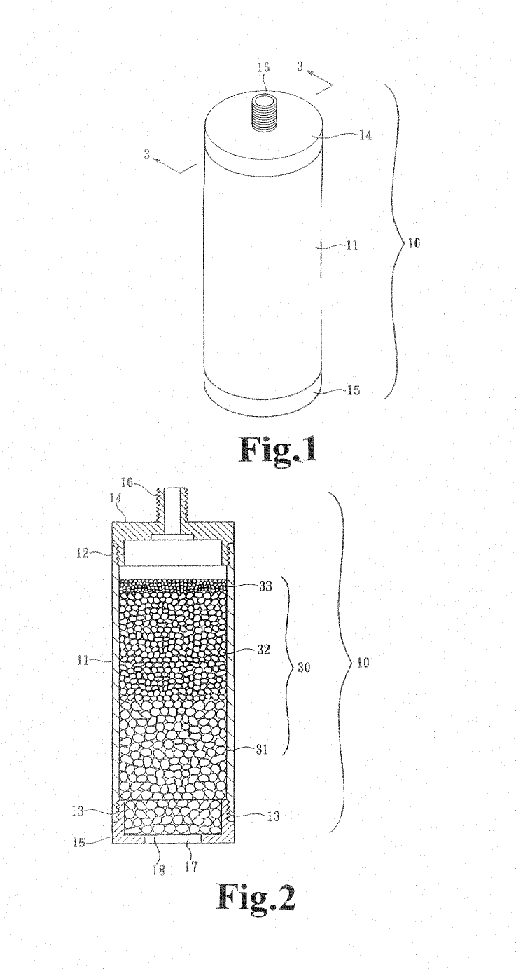

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

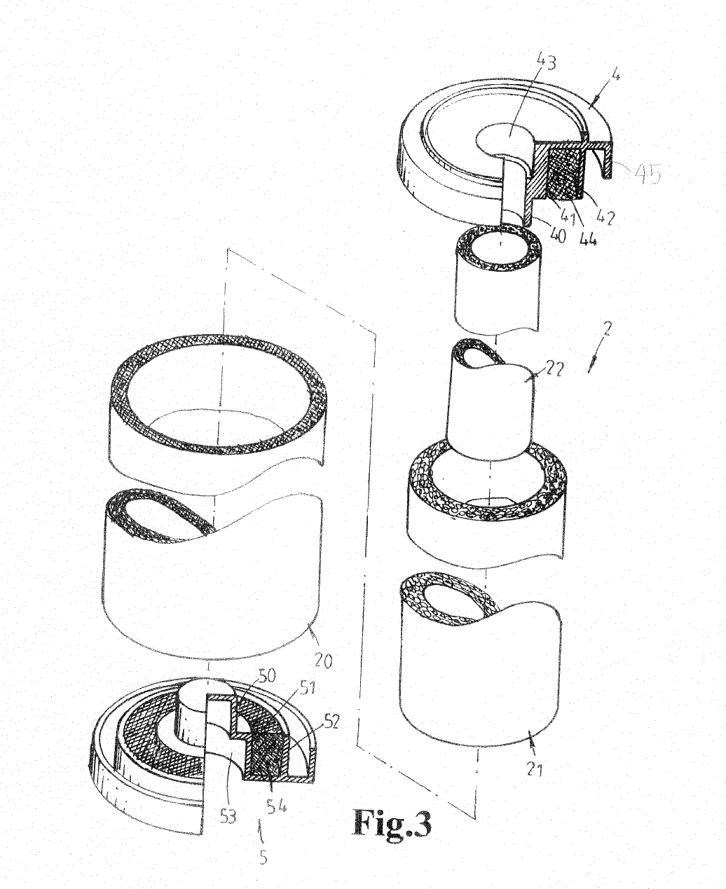

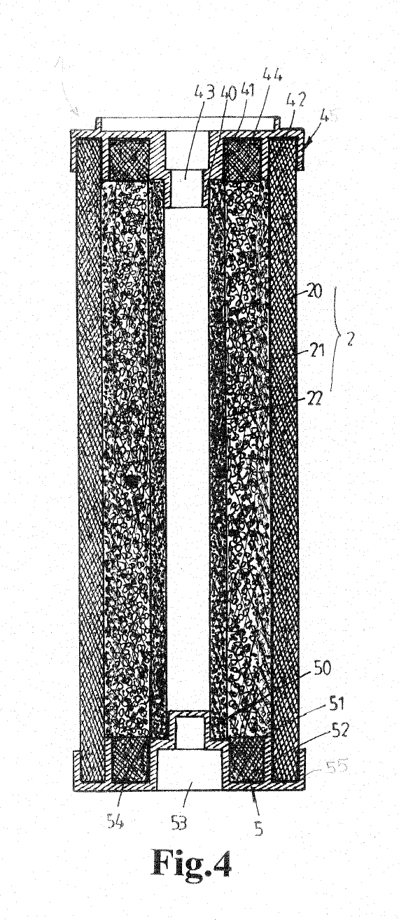

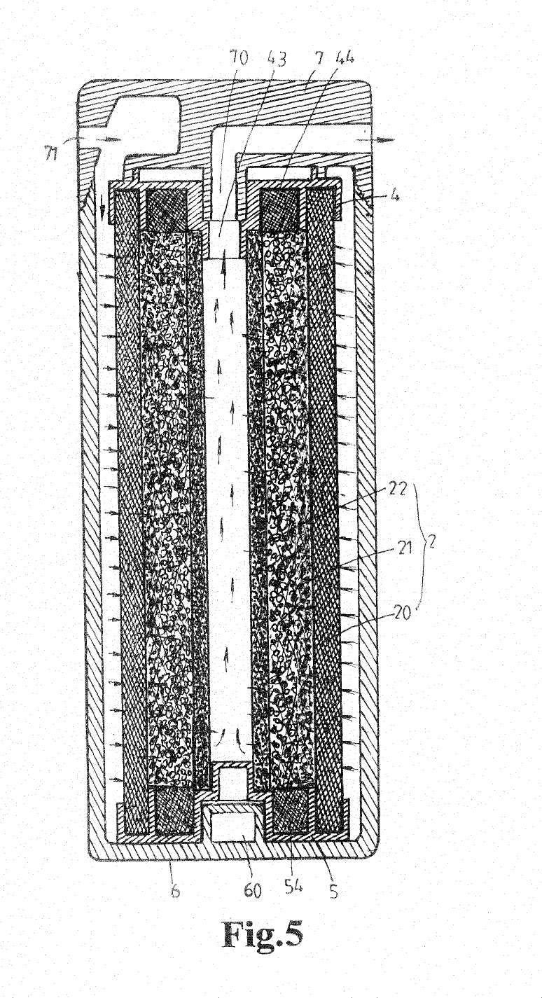

With reference to FIGS. 3 and 4, a compound material 2 is installed between the upper supporting seat 4 and the lower supporting seat 5. The compound material 2 is formed with an high density fiber layer 22, an active carbon layer 21 surrounding the high density fiber layer 22 and a fiber layer 20 surrounding the active carbon layer 21.

The upper supporting seat 4 has a cover plate. An inner ring 41 protrudes from a lower side of the cover plate of the upper supporting seat 4. A reduced ring 40 protrudes from a lower side of the inner ring 41 so as to form with a platform at the lower side of the inner ring 41 and surround the reduced ring 40. A middle ring 42 protrudes from the cover plate and surrounds the inner ring 41. An outer ring 45 protrudes from the lower side of the cover plate and surrounds the middle ring 42. A central portion of the upper supporting seat 4 is formed with a water outlet 43. A fiber filtering material 44 is placed into a space between the inner ring 41 and the middle ring 42.

The lower supporting seat 5 has a cover plate. An inner ring 51 protrudes from an upper side of the cover plate of the lower supporting seat 5. The reduced ring 50 protrudes from an upper side of the inner ring 51 so as to form with a platform at the upper side of the inner ring 51 and surrounding the reduced ring 50. A middle ring 52 protrudes from the cover plate and surrounds the inner ring 51. An outer ring 55 protrudes from the upper side of the cover plate of the lower supporting seat 5 and surrounds the middle ring 52. A central portion of a lower side of the lower supporting seat 5 is formed with a lower recess 53. A fiber filtering material 54 is placed into a space between the inner ring 51 and the middle ring 52.

The high density fiber layer 22 is installed between the platform of the upper supporting seat 4 and the platform of the lower supporting seat 5.

The active carbon layer 21 is installed between the fiber filtering material 44 of the upper supporting seat 4 and the fiber filtering material 54 of the lower supporting seat 5.

The fiber layer 20 is installed between the upper supporting seat 4 and the lower supporting seat 5. One end of the fiber layer 20 is engaged to a recess between the middle ring 42 of the upper supporting seat 4 and the outer ring 45 of the upper supporting seat 4. Another end of the fiber layer 20 is engaged to a recess between the middle ring 52 of the lower supporting seat 5 and the outer ring 55 of the lower supporting seat 5.

In installation, the filter structure of the present invention is placed into a casing 6. A protruding post 60 of the casing is placed into the lower recess 53 of the lower supporting seat 5. An upper cover 7 is screwed into the casing 6. A water outlet 70 is connected to the water outlet 43 of the upper supporting seat 4. Water flows into the water inlet 71 to the casing 6 to be filled the periphery of the fiber layer 20 for being filtered. Then the water flows to the active carbon layer 21 to be further filtered. Then the water flows to the high density fiber layer 22. Then the water flows out from the water outlet 43 of the upper supporting seat 4 and the water outlet 70 of the upper cover 7.

If it is desired to update the filter of the present invention, it is only necessary to release the upper cover 7 and then detach the casing 6. Then the filter structure of the present invention can be updated. Or the upper supporting seat 4 and the lower supporting seat 5 can be further detached for update one of the filter material of the fiber layer 20, active carbon layer 21 and the high density fiber layer 22. No tool is used. The operation is easy and quick.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A filter for filtering water, comprising:
a compound material installed between the upper supporting seat and the lower supporting seat; the compound material being formed with an high density fiber layer, an active carbon layer surrounding the high density fiber layer and a fiber layer surrounding the active carbon layer;
the upper supporting seat having a cover plate; an inner ring protruding from a lower side of the cover plate of the upper supporting seat; a reduced ring protruding from a lower side of the inner ring so as to form with a platform at the lower side of the inner ring and surround the reduced ring; a middle ring protruding from the cover plate and surrounds the inner ring of the upper supporting seat; an outer ring protruding from the lower side of the cover plate and surrounds the middle ring of the upper supporting seat; a central portion of the upper supporting seat being formed with a water outlet; a fiber filtering material being placed into a space between the inner ring and the middle ring;
the lower supporting seat having a cover plate; an inner ring protruding from an upper side of the cover plate of the lower supporting seat; the reduced ring protruding from an upper side of the inner ring so as to form with a platform at the upper side of the inner ring and surround the reduced ring; a middle ring protruding from the cover plate and surrounds the inner ring of the lower supporting seat; an outer ring protruding from the upper side of the cover plate of the lower supporting seat and surrounding the middle ring of the lower supporting seat; a central portion of a lower side of the lower supporting seat being formed with a lower recess; and a fiber filtering material being placed into a space between the inner ring and the middle ring;
the high density fiber layer being installed between the platform of the upper supporting seat and the platform of the lower supporting seat;
the active carbon layer being installed between the fiber filtering material of the upper supporting seat and the fiber filtering material of the lower supporting seat;
the fiber layer being installed between the upper supporting seat and the lower supporting seat; one end of the fiber layer being engaged to a recess between the middle ring of the upper supporting seat and the outer ring of the upper supporting seat; another end of the fiber layer being engaged to a recess between the middle ring of the lower supporting seat and the outer ring of the lower supporting seat.

2. The filter for filtering water as claimed in claim 1, wherein in installation, the filter structure is placed into a casing; a protruding post of the casing is placed into the lower recess of the lower supporting seat; an upper cover is screwed into the casing; a water outlet is connected to the water outlet of the upper supporting seat; water flows into the water inlet to the casing to be filled a periphery of the fiber layer for being filtered; then the water flows to the active carbon layer to be further filtered; then the water flows to the high density fiber layer; then the water flows out from the water outlet of the upper supporting seat and the water outlet of the upper cover.
